(19) United States
(12) Patent Application Publication
(10) Pub. No.: US 2009/0188939 A1
(43) Pub. Date: Jul. 30, 2009

(54) METHOD AND APPARATUS FOR DISPENSING FLUIDS FROM ORGANIC CONTAINERS

(76) Inventor: Robert M. McCoy, Victorville, CA (US)

Correspondence Address: PATENT VENTURE GROUP, 10788 CIVIC CENTER DRIVE, SUITE 215, RANCHO CUCAMONGA, CA, 91730, US

(21) Appl. No.: 12/022,976

(22) Filed: Jan. 30, 2008

(51) Int. Cl. B67D 5/00

(52) U.S. Cl. 222/91

(57) ABSTRACT

An invention is provided for a manually controllable produce stent. The manually controllable produce stent includes a fluid control mechanism capable of stopping a flow of fluid and also allowing a flow of fluid through the fluid control mechanism. In addition, the manually controllable produce stent includes a stent body in fluid communication with the fluid control mechanism. The stent body is capable of stenting an organic membrane of a hollowed organic container and includes a hollow interior capable of providing fluid to the fluid control mechanism. Optionally, a serrated cutting aperture can be disposed at an end of the stent body opposite the fluid control mechanism, which is capable of cutting an opening in the organic membrane of the hollowed organic container.

### BACKGROUND OF THE INVENTION

1. Field of the Invention

This invention relates generally to dispensing mechanisms, and more particularly to methods and apparatuses for dispensing fluids from organic containers.

2. Description of the Related Art

Today, many households consume a great deal of fluids and beverages, such as water, wine, tea, distilled spirits, and fruit drinks on a daily basis. Obviously, to facilitate such consumptions containers are utilized to hold and store these fluids. Conventional containers generally are manufactured from glass, plastic, aluminum, or some combination of the preceding items. In general, these containers are not very attractive, are non-biodegradable, and in some cases may be unsafe, such as glass containers in a swimming pool environment.

In addition conventional containers require a substantial amount of non-renewable energy to produce. As is well known, it is desirable to reduce society's carbon footprint, reduce climate change, and reduce global warming. By reducing the use of oil dependant products such as plastic containers, which are more than 50% oil based, and reducing the use of energy demanding products such as metal products, which require substantial energy to convert the basic ore into metal, the carbon footprint of society can be drastically reduced.

In view of the foregoing, there is a need for methods and apparatuses that provide fluid containers for dispensing the fluids and beverages, such as water, wine, tea, distilled spirits, fruit drinks, and other fluids consumed on a daily basis. The methods and apparatuses should provide containers that are not overly reliant on non-biodegradable material and should include reusable elements that are not generally disposed.

### SUMMARY OF THE INVENTION

Broadly speaking, embodiments of the present address these needs by providing a method and apparatus for dispensing fluids from organic containers formed from articles of agricultural produce. In this manner, embodiments of the present invention can be utilized to create fluid containers anywhere using carved organic containers and any desired fluid. For example, in one embodiment, a manually controllable produce stent is disclosed. The manually controllable produce stent includes a fluid control mechanism capable of stopping a flow of fluid and also allowing a flow of fluid through the fluid control mechanism. In addition, the manually controllable produce stent includes a stent body in fluid communication with the fluid control mechanism. The stent body is capable of stenting an organic membrane of a hollowed organic container and includes a hollow interior capable of providing fluid to the fluid control mechanism. In addition, a serrated cutting aperture can be disposed at an end of the stent body opposite the fluid control mechanism, which is capable of cutting an opening in the organic membrane of the hollowed organic container. The stent body can also include a threaded screw section disposed adjacent to the fluid control mechanism to assist in holding the manually controllable produce stent in position. Further, a plurality of fluid collection openings can be disposed in a side area of the stent body to facilitate fluid flow into the interior of the stent body.

A method for dispensing fluids from an organic container is disclosed in a further embodiment of the present invention. The method includes removing inner material from an article of agricultural produce, wherein an organic membrane of the article of agricultural produce remains forming an organic container. The organic membrane is stented utilizing the manually controllable produce stent, which as described above, comprises a stent body and a fluid control mechanism. The manually controllable produce stent is situated such that the stent body is disposed in an inner area of the organic container and the fluid control mechanism is disposed outside the organic container. Thereafter, fluid is inserted into the inner area of the organic container such that the stent body is immersed in the fluid. In addition, the organic container can be placed on a stand, formed for example from a plurality of interlinked wooden beams, which is capable of allowing the organic container to rest in an upright position. To facilitate removal of the inner material, an end of the article of agricultural produce can be removed. Here, the removed end of the article of agricultural produce can be replaced back onto the organic container after fluid is inserted into the inner area of the organic container, thus forming an organic “lid” for the organic container. In this manner, embodiments of the present invention advantageously provide a means to create fluid containers anywhere utilizing agricultural produce and any desired fluid, such as water, punch, wine, or any other fluid desired. Moreover, once the organic fluid server is no longer needed, the manually controllable produce stent can be removed from the organic container and the organic container discarded. Thus, utilizing the embodiments of the present invention, various decorative organic fluid servers can be created utilizing various types of agricultural produce. For example, embodiments of the present invention can be utilized to create decorative organic fluid servers that fit any particular occasion, such as pumpkin based organic fluid servers for Halloween festivities, watermelon based organic fluid servers for summer parties, and pineapple based organic fluid servers for evening parties. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a manually controllable produce stent, in accordance with an embodiment of the present invention;

FIG. 2 is a diagram showing an organic fluid server comprising a manually controllable produce stent stenting an organic container, in accordance with an embodiment of the present invention;

FIG. 3 is a flowchart showing a method for proving an organic fluid server utilizing a manually controllable produce stent, in accordance with an embodiment of the present invention;

FIG. 4 is a diagram showing an organic container formed from an article of agricultural produce, in accordance with an embodiment of the present invention; and

FIG. 5 is a diagram illustrating a manually controllable produce stent stenting an organic membrane of an organic container, in accordance with an embodiment of the present invention.

### DETAILED DESCRIPTION OF THE PREFERRED EMBODIMENTS

An invention is disclosed for dispensing fluids from organic containers using a manually controllable produce stent. Broadly speaking, embodiments of the present invention provide a means to create fluid containers anywhere utilizing organic containers and any desired fluid. Organic containers can be, for example, a fruit or vegetable wherein the inner material of the fruit or vegetable has been removed leaving the surrounding shell. A manually controllable produce stent of the embodiments of the present invention is then inserted into the shell, which can thereafter be utilized as an organic container to hold a desired fluid, such as water, punch, wine, or any other fluid desired. In this manner, the organic container can be utilized to hold and dispense a desired fluid, such as a beverage.

In the following description, the term organic container shall refer to any container formed from a fruit or vegetable that has been hollowed out to remove the inner material of the fruit or vegetable leaving a surrounding shell. In addition, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

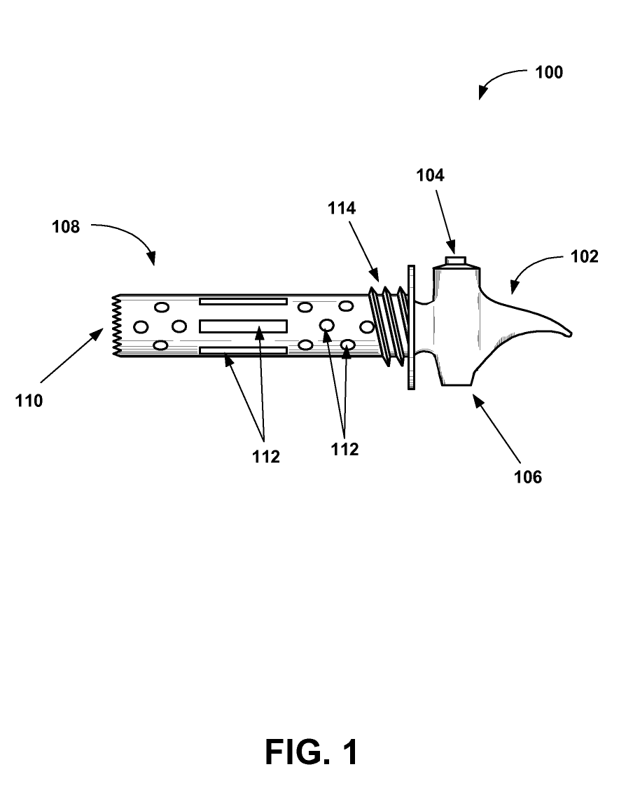

Referring now to the drawings, FIG. 1 is an illustration showing a manually controllable produce stent 100, in accordance with an embodiment of the present invention. It should be borne in mind that the embodiments of the present invention can be utilized with any organic container, such as organic containers formed from any type of fruit and/or vegetable. As illustrated in FIG. 1, the manually controllable produce stent 100 includes a fluid control mechanism 102 and a stent body 108. The fluid control mechanism 102 generally includes a flow control device 104 and a fluid dispensing nozzle 106. The stent body 108 generally includes a serrated cutting aperture 110, a plurality of fluid collection openings 112, and a threaded screw section 114. In one embodiment, the manually controllable produce stent 100 is manufactured as a single body. However, it should be noted that the fluid control mechanism 102 and the stent body 108 can be separately manufactured and thereafter attached together via application of standard adhesive and force fit creating a durable and reliable bonding. The manually controllable produce stent 100 can be manufactured from any suitable material, such as plastic, aluminum, and/or steel.

In operation, the fluid control mechanism 102 is utilized to control the flow of fluid through the manually controllable produce stent 100. More particularly, the flow control device 104 is utilized to stop or allow the flow of fluid. When set to allow the flow of fluid, or to an ON position, fluid is allowed to exit the fluid control mechanism 102 via the fluid dispensing nozzle 106. The flow of fluid from the fluid dispensing nozzle 106 can thereafter be stopped by setting the flow control device 104 to a stop, or OFF, position. Thus, the fluid control mechanism 102 is capable of both allowing the flow of fluid through the fluid control mechanism 102 and stopping the flow of fluid through fluid control mechanism 102, depending of the setting of the flow control device 104.

In FIG. 1, the fluid control mechanism 102 is illustrated as a push button operated on-off device that controls the flow of the fluid through the fluid control mechanism 102. That is, the flow control device 104 is illustrated as a button device wherein depressing the button sets the flow control device 104 to an ON position, allowing fluid to exit the fluid control mechanism 102 via the fluid dispensing nozzle 106. The flow control device 104 returns to the OFF position when the button is later released, stopping the flow of fluid. Although illustrated in FIG. 1 as a push button based device, it should be noted that the fluid control mechanism 102 can be any mechanism capable of controlling the flow of fluid, such as a lever based mechanism or switched based mechanism, capable of stopping and allowing the flow of fluid through the fluid control mechanism 102, as will be apparent to those skilled in the art after a careful reading of the present disclosure.

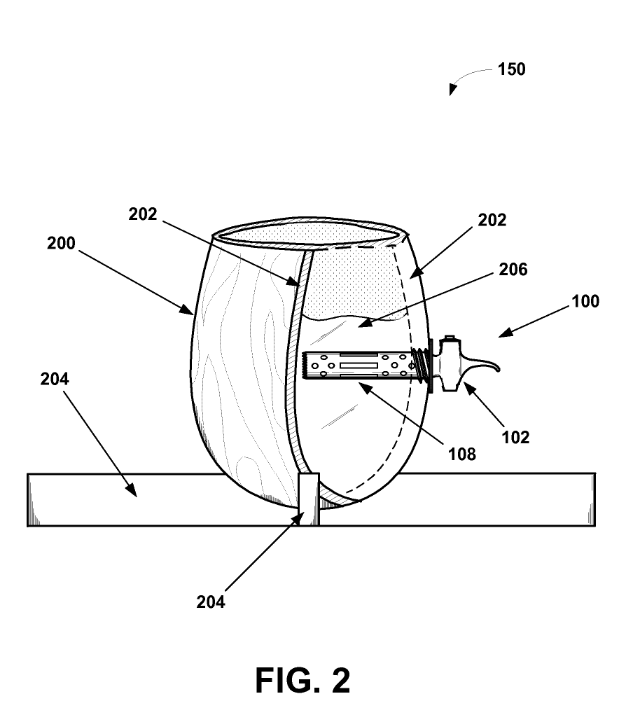

The stent body 108 portion of the manually controllable produce stent 100 is utilized for stenting an organic membrane of a hollowed organic container and providing fluid located therein to the fluid control mechanism 102. As will be described in greater detail subsequently, the serrated cutting aperture 110 of the stent body 108 facilitates stenting of the organic container providing a means to cut an opening in the organic membrane of the hollowed organic container. In the present description, the term “stenting” shall be construed to mean inserting the stent body 108 into an organic membrane of an organic container in such a manner so as hold and maintain an opening to allow fluid located therein to flow through the stent body 108 to the fluid control mechanism 102. Once the stent body 108 is inserted into the organic membrane of the organic container, the manually controllable produce stent 100 can be rotated to allow the threaded screw section 114 of the stent body 108 to screw into the organic membrane, thus securing the manually controllable produce stent 100 to the organic container, as illustrated next with reference to FIG. 2.

FIG. 2 is a diagram showing an organic fluid server 150 comprising a manually controllable produce stent 100 stenting an organic container 200, in accordance with an embodiment of the present invention. As illustrated in FIG. 2, the organic container 200 comprises an organic membrane 202 formed by removing the interior material from a fruit or vegetable. For example, FIG. 2 illustrates an organic container 200 from a watermelon, wherein the top of the watermelon is cut off and the inner pulp of the watermelon is removed. Once inner pulp is removed, the stent body 108 of the manually controllable produce stent 100 is utilized to stent the organic membrane 202 of the organic container 200.

To help keep the organic container 200 upright, a stand 204 can be disposed below the organic container 200. For example, in one embodiment, the stand 204 can be formed from two pieces of wood fit flush together in an “X” or “+” formation. In addition, a depression can be created in the top portion of the stand 204 at the intersection of the two wood pieces. For example, when utilizing a watermelon based organic container 200 as illustrated in FIG. 2, the depression can be in the range of about 5 to 7 inches in diameter and in the range of about 2 to 3 inches deep. The depression creates a space for the organic container 200 to rest in, allowing the organic container 200 to stand in an upright position.

Also illustrated in FIG. 2, is the inclusion of fluid 206 disposed within the inner area formed from the organic membrane 202 of the organic container 200. As mentioned previously, the organic container 200 can hold any desired fluid 206, such as water, punch, wine, or any other fluid desired. Once the fluid 206 is poured into the organic container 200, the manually controllable produce stent 100 controls the flow of the fluid 206 out of the organic container 200. The fluid 206 generally is provided to the fluid control mechanism 102 via the stent body 108. More specifically, the fluid 206 enters the stent body 108 via the serrated cutting aperture 110 and the plurality of fluid collection openings 112. The fluid control mechanism 102 then is utilized to control the flow of fluid 206 out of the organic container 200 through the fluid dispensing nozzle 106 of the fluid control mechanism 102.

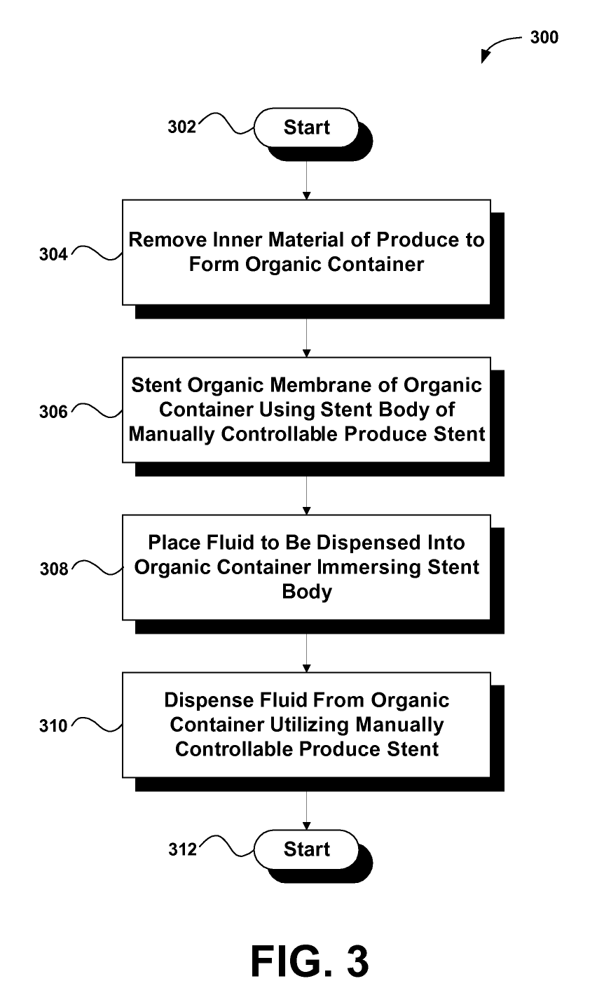

FIG. 3 is a flowchart showing a method 300 for proving an organic fluid server utilizing a manually controllable produce stent, in accordance with an embodiment of the present invention. In an initial operation 302, preprocess operations are performed. Preprocess operations can include, for example, determining a type of fruit or vegetable to be utilized as the basis for the organic container, selecting a desired fluid to be utilized with the organic fluid server, and other preprocess operations that will be apparent to those skilled in the art after a careful reading of the present disclosure.

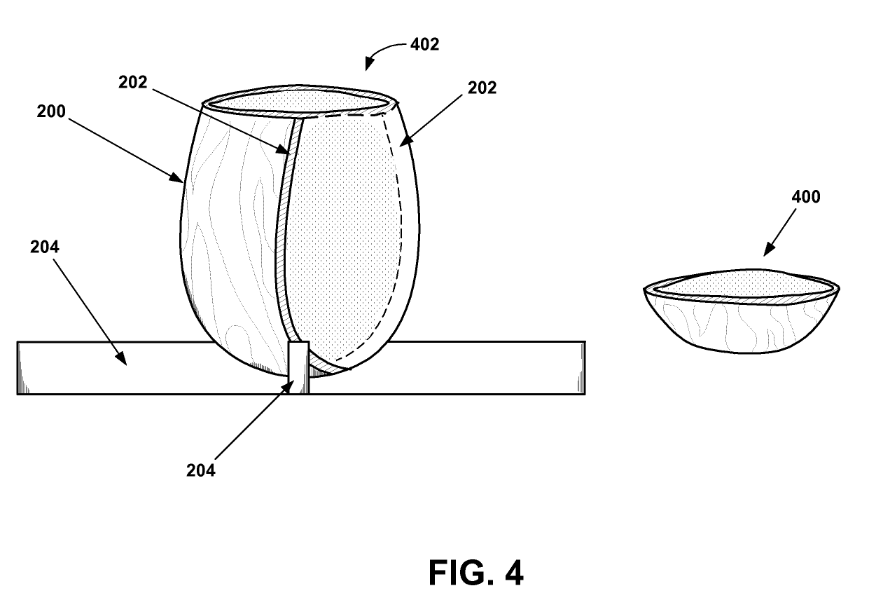

In operation 304, the inner material of a fruit or vegetable is removed to form an organic container. FIG. 4 is a diagram showing an organic container 200 formed from an article of agricultural produce, in accordance with an embodiment of the present invention. As illustrated in FIG. 4, removal of an end of the fruit or vegetable can facilitate removal of the inner material. For example, in FIG. 4 the top end 400 of a watermelon is removed from the watermelon to expose the inner area of the fruit. Thereafter, the inner material of the fruit, (i.e., watermelon in the example of FIG. 4) is removed forming an organic container 200 from the remaining organic membrane 202 of the surrounding shell. Although FIG. 4 illustrates an organic container 200 formed from a watermelon, it should be noted that the embodiments of the present invention can be utilized with any type of agricultural produce, such a other types of fruit and vegetables. In addition, as described previously, the resulting organic container 200 can be placed on a stand 204 to allow the organic container 200 to stand in an upright position wherein the top opening 402 of the organic container 200 is disposed upward as illustrated in FIG. 4. In addition, the top end 400 of the organic container 200 can be saved and later placed over the top opening 402 to form a top lid for the resulting organic fluid server.

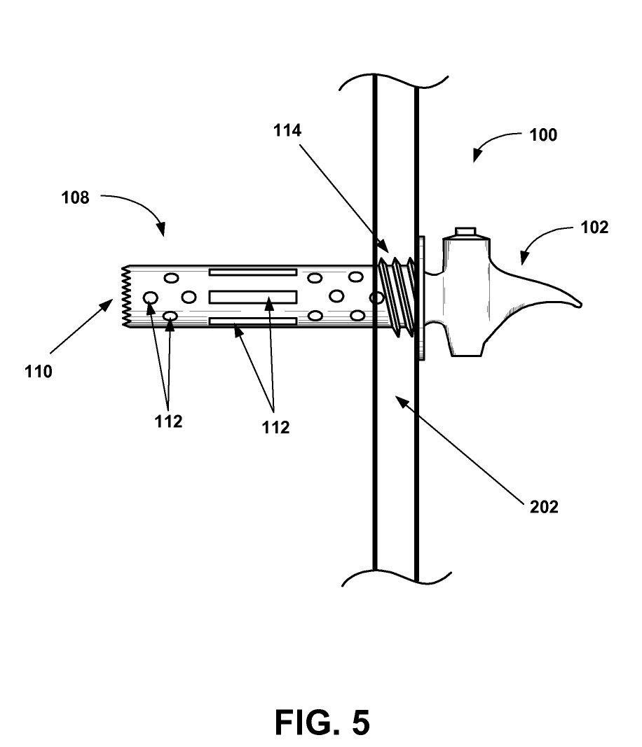

Referring back to FIG. 3, the organic membrane of the organic container formed in operation 306 is stented utilizing the stent body of the manually controllable produce stent. FIG. 5 is a diagram illustrating a manually controllable produce stent 100 stenting an organic membrane 202 of an organic container, in accordance with an embodiment of the present invention. The serrated cutting aperture 110 of the stent body 108 facilitates stenting of the organic membrane 202 of the organic container providing a means to cut an opening in the organic membrane of the hollowed organic container. In this manner, the stent body 108 holds and maintains an opening in the organic membrane 202 to later allow fluid located therein to flow through the stent body 108 to the fluid control mechanism 102. Once the stent body 108 is disposed in the organic membrane 202 of the organic container, the manually controllable produce stent 100 can be rotated to allow the threaded screw section 114 of the stent body 108 to screw into the organic membrane 202, thus securing the manually controllable produce stent 100 to the organic membrane 202 of the organic container. In one embodiment, the serrated cutting aperture 110 portion of the stent body 108 is tapered so as to be slightly smaller in diameter than the general area of the stent body 108. In this manner, the serrated cutting aperture 110 creates an opening in the organic membrane 202 that is slightly smaller in diameter than the general area of the stent body 108. As a result, a snug fit is created between the stent body 108 and the organic membrane 202 because the stent body 108 is required to squeeze through the slightly smaller opening in the organic membrane 202. This snugness helps prevent fluid from leaking between the stent body 108 and the organic membrane 202.

Turning back to FIG. 3, in operation 308, fluid is placed into the organic container such that the stent body of the manually controllable produce stent is immersed in the fluid. Referring to FIG. 2, the desired fluid 206 to be dispensed is placed into the inner area of the organic container 200. In general, the fluid control mechanism of the manually controllable produce stent 100 will be in an OFF position, preventing the fluid 206 from flowing out of the organic container 200 until dispensing is desired.

Then, in operation 310 of the FIG. 3, the manually controllable produce stent is utilized to dispense fluid from the organic container. Referring back to FIG. 2, the stent body 108 stents the organic membrane 202 to allow the fluid 206 located within the inner area of the organic container 200 to be provided to the fluid control mechanism 102. The fluid control mechanism 102 can then be utilized to dispense fluid 206 from of the organic container 200.

Post process operations are performed in operation 312. Post process operations can include, for example, placing ice in the fluid in the inner area of the organic container, placing the top end of the organic container over the top opening to form a “lid” for the organic container, and other post process operations that will be apparent to those skilled in the art after a careful reading of the present disclosure. In this manner, embodiments of the present invention advantageously provide a means to create fluid containers anywhere utilizing agricultural produce and any desired fluid, such as water, punch, wine, or any other fluid desired. Moreover, once the organic fluid server is no longer needed, the manually controllable produce stent can be removed from the organic container and the organic container discarded. Thus, utilizing the embodiments of the present invention, various decorative organic fluid servers can be created utilizing various types of agricultural produce. In this manner, embodiments of the present invention can be utilized to create decorative organic fluid servers that fit any particular occasion, such as pumpkin based organic fluid servers for Halloween festivities, watermelon based organic fluid servers for summer parties, and pineapple based organic fluid servers for evening parties.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A manually controllable produce stent, comprising:
a fluid control mechanism capable of stopping a flow of fluid and allowing a flow of fluid through the fluid control mechanism; and
a stent body in fluid communication with the fluid control mechanism, the stent body capable of stenting an organic membrane of a hollowed organic container, the stent body further having a hollow interior capable of providing fluid to the fluid control mechanism.

2. A manually controllable produce stent as recited in claim 1, wherein the stent body further includes a serrated cutting aperture disposed at an end of the stent body opposite the fluid control mechanism.

3. A manually controllable produce stent as recited in claim 2, wherein the serrated cutting aperture is capable of cutting an opening in the organic membrane of the hollowed organic container.

4. A manually controllable produce stent as recited in claim 1, wherein the stent body further includes a threaded screw section disposed adjacent to the fluid control mechanism.

5. A manually controllable produce stent as recited in claim 1, wherein the stent body further includes a plurality of fluid collection openings disposed in a side area of the stent body.

6. A manually controllable produce stent as recited in claim 5, wherein each fluid collection opening of the plurality of fluid collection openings is capable of allowing fluid to flow into the stent body through the fluid collection opening.

7. A manually controllable produce stent as recited in claim 1, wherein the hollowed organic container is formed from an article of agricultural produce.

8. A method for dispensing fluids from an organic container, compromising the operations of:
removing inner material from of an article of agricultural produce, wherein an organic membrane of the article of agricultural produce remains forming an organic container;
stenting the organic membrane utilizing a manually controllable produce stent comprising a stent body and a fluid control mechanism, wherein the stent body is disposed in an inner area of the organic container and the fluid control mechanism is disposed outside the organic container; and
inserting a fluid into the inner area of the organic container such that the stent body is immersed in the fluid.

9. A method as recited in claim 8, wherein a serrated cutting aperture of the stent body is utilized to facilitate stenting of the organic membrane.

10. A method as recited in claim 8, further comprising the operation of dispensing the fluid from the organic container utilizing the fluid control mechanism.

11. A method as recited in claim 10, wherein the fluid control mechanism is capable of stopping a flow of fluid and allowing a flow of fluid through the fluid control mechanism.

12. A method as recited in clam 8, further comprising the operation of placing the organic container on a stand, wherein the stand is capable of allowing the organic container to rest in an upright position.

13. A method as recited in claim 12, wherein the stand is formed utilizing a plurality of interlinked wooden beams.

14. A method as recited in claim 8, further comprising the operation of removing an end of the article of agricultural produce to facilitate removal of the inner material.

15. A method as recited in claim 14, further comprising the operation of replacing the removed end of the article of agricultural produce onto the organic container after fluid is inserted into the inner area of the organic container.
